(19) United States
(12) Patent Application Publication
(10) Pub. No.: US 2002/0139344 A1
(43) Pub. Date: Oct. 3, 2002

(54) Built-in engine type control apparatus

(75) Inventors: Masashi Kitada, Shizuoka (JP); Haruhiko Sato, Shizuoka (JP); Keizo Nishitani, Shizuoka (JP)

Correspondence Address: SUGHRUE MION, PLLC, 2100 PENNSYLVANIA AVENUE, N.W., WASHINGTON, DC, 20037, US

(73) Assignee: YAZAKI CORPORATION

(21) Appl. No.: 10/109,887

(22) Filed: Apr. 1, 2002

(30) Foreign Application Priority Data
Apr. 2, 2001 (JP) P2001-103304

(51) Int. Cl. F02F 7/00

(52) U.S. Cl. 123/195 C; 123/195 E

(57) ABSTRACT

In a built-in engine type control apparatus which is coupled to electric parts attached to the outer periphery of an engine and has a branch circuit, the apparatus includes a cylinder head cover (4) formed by heat resistant insulating material, and a bus bar circuit body (8) which is buried in the cylinder head cover and in which a branch circuit portion (9) is formed and a plurality of contact points (10a to 10g) to be coupled to the electric parts are formed integrally with terminals, wherein connector fitting portions (12a to 12f) are provided at the peripheries of the plurality of the contact points, respectively, and a connector 37 coupled to electric parts such as a temperature detection sensor (30a), a cam shaft phase detection sensor (30b) etc. is fitted into the connector fitting portions (12a to 12f).

### BACKGROUND OF THE INVENTION

The present invention relates to a built-in engine type control apparatus provided integrally with an engine.

As such a kind of related built-in engine type control apparatus 100, there is one disclosed in Japanese Patent Laid-Open No. 317556/1997 as shown in FIGS. 10 and 11. As shown in FIGS. 10 and 11, a cylinder head cover 101 is provided with a wiring portion (a brunch circuit portion) 102 disposed along the wall surface of the cylinder head cover, a plurality of contact points 103 coupled to the terminals of the wiring portion 102, and a plurality of connector fitting portions 104 each provided at the periphery of a corresponding block of the plurality of the contact points 103 disposed closely from one another. Connectors (not shown) to be coupled to electronic parts, an engine control unit etc. are fitted into these connector fitting portions 104, respectively.

According to the built-in engine type control apparatus 100 thus configured, the wiring portion 102 is arranged at the cylinder head cover 101, and both the contact points 103 and the connector fitting portions 104 can be freely disposed at the suitable portions of the cylinder head cover 101, so that the related built-in engine type control apparatus is advantageous in that an amount of the wire harnesses to be wired around the engine can be reduced extremely.

However, according to the related built-in engine type control apparatus 100, since it is required to couple the wiring portion (brunch circuit portion) 102 and the plurality of the contact points 103 by any means, there arises a problem that the manufacturing process of the apparatus is complicated and the cost thereof is high.

### SUMMARY OF THE INVENTION

Accordingly, the invention has been made in order to solve the aforesaid problem of the conventional technique, and an object of the invention is to provide a built-in engine type control apparatus which can be manufactured easily and at a low cost.

In order to solve the aforesaid object, the invention is characterized by having the following arrangement.

(1) A built-in engine type control apparatus comprising:

an apparatus main body formed by heat resistant insulating material; and

a bus bar circuit body which is buried in the apparatus main body and includes a branch circuit portion and a plurality of contact points, to be coupled to electric parts attached to outer periphery of an engine, each of which are integrally formed at terminals of the branch circuit portion, respectively.

(2) The built-in engine type control apparatus according to (1), wherein a connector fitting portion at which the plurality of contact points are disposed and in which a connector coupled to the electric parts is fitted is provided at the apparatus main body.

(3) The built-in engine type control apparatus according to (2), wherein a fitting direction in which the connector coupled to the electric parts is fitted to the connector fitting portion is set to be substantially same as a vibration direction of the engine.

(4) The built-in engine type control apparatus according to (1), wherein the apparatus main body is a cylinder head cover which closes an opening at an upper portion of the engine.

According to the built-in engine type control apparatus, since the branch circuit portion and the plurality of the contact points are integrally formed by the bus bar circuit body by using the terminal portions, it is not necessary to provide a process of coupling the branch circuit portion and the plurality of the contact points like the conventional technique.

According to the built-in engine type control apparatus, the electric parts can be coupled by fitting the connector on the electric part side into the connector fitting portion of the apparatus main body.

According to the built-in engine type control apparatus, the vibration in the mutually sliding direction acts on each of the contact points due to the vibration of the engine.

According to the built-in engine type control apparatus, it is not necessary to provide, separately from the cylinder head cover, a member in which the bus bar circuit body is buried.

### BRIEF DESCRIPTION OF THE DRAWINGS

FIG. 1 shows an embodiment of the invention and is a perspective view of the engine seen from the suction side thereof.

FIG. 2 shows the embodiment of the invention and is a perspective view of the engine seen from the exhaust side thereof.

FIG. 3 shows the embodiment of the invention and is a perspective view showing a cylinder head cover seen from the suction side in which a bus bar circuit body is looked through and shown clearly.

FIG. 4 shows the embodiment of the invention and is a perspective view showing the cylinder head cover seen from the exhaust side in which the bus bar circuit body is looked through and shown clearly.

FIG. 5 shows the embodiment of the invention and is a partially cutaway views of the cylinder head cover seen from the exhaust side.

FIG. 6 shows the embodiment of the invention and is a partially cutaway views of the cylinder head cover seen from the exhaust side.

FIG. 7 shows the embodiment of the invention and is a partially cutaway views of the cylinder head cover seen from the exhaust side.

FIGS. 8A and 8B show the embodiment of the invention and further FIG. 8A is a perspective view showing a state before a contact point on an engine control unit side and a contact point on the cylinder head cover side are made in contact, and FIG. 8B is a perspective view showing a state where the contact point on the engine control unit side and the contact point on the cylinder head cover side are made in contact.

FIG. 9 shows the embodiment of the invention and is a sectional view showing a state where a built-in ignition coil type igniter is attached.

FIG. 10 is a perspective view of a cylinder had cover to which an example of the related built-in engine type control apparatus is applied.

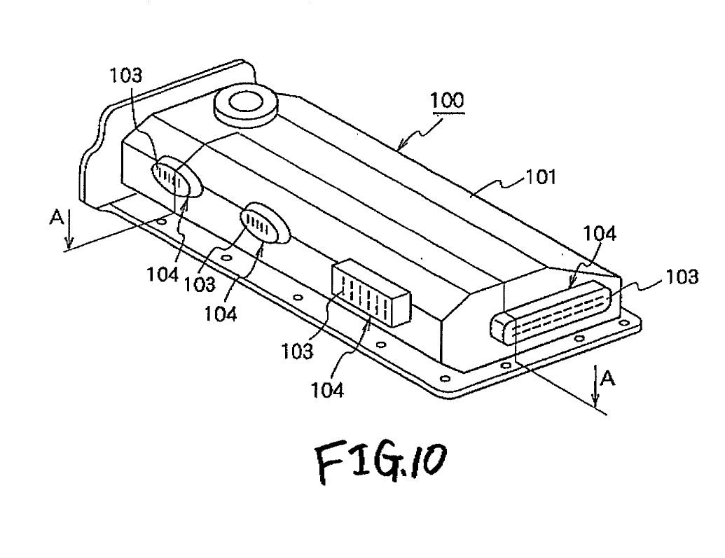

FIG. 11 is a sectional view along a line A-A in FIG. 10.

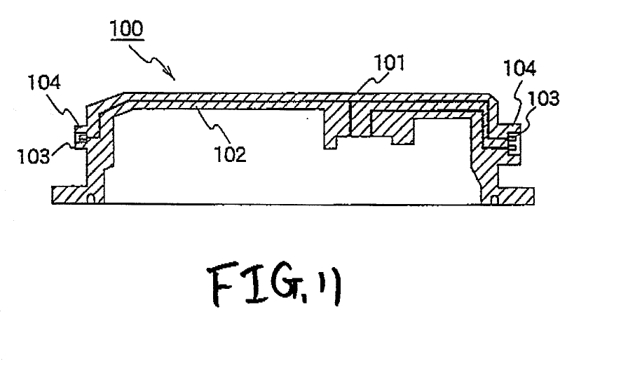

### DETAILED DESCRIPTION OF PREFERRED EMBODIMENTS

Hereinafter, the embodiment of the invention will be explained with reference to the accompanying drawings.

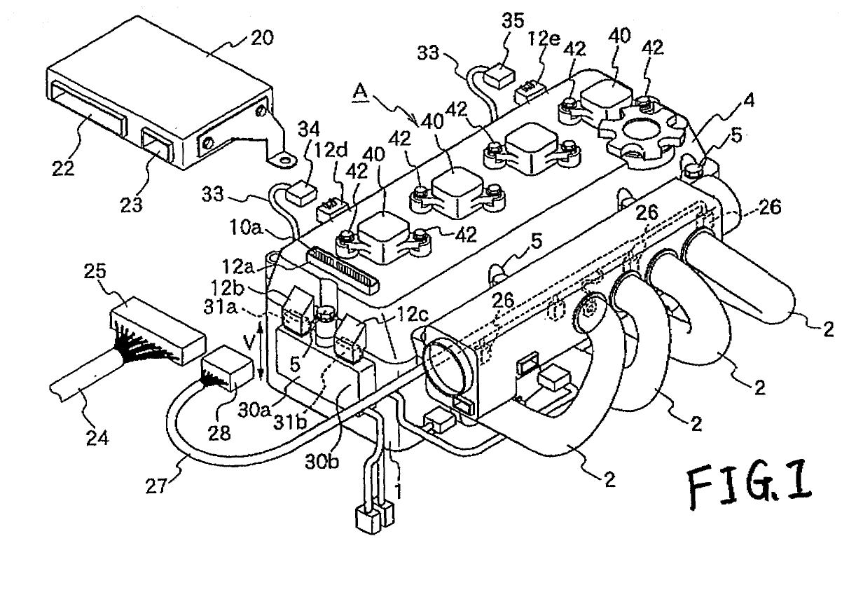

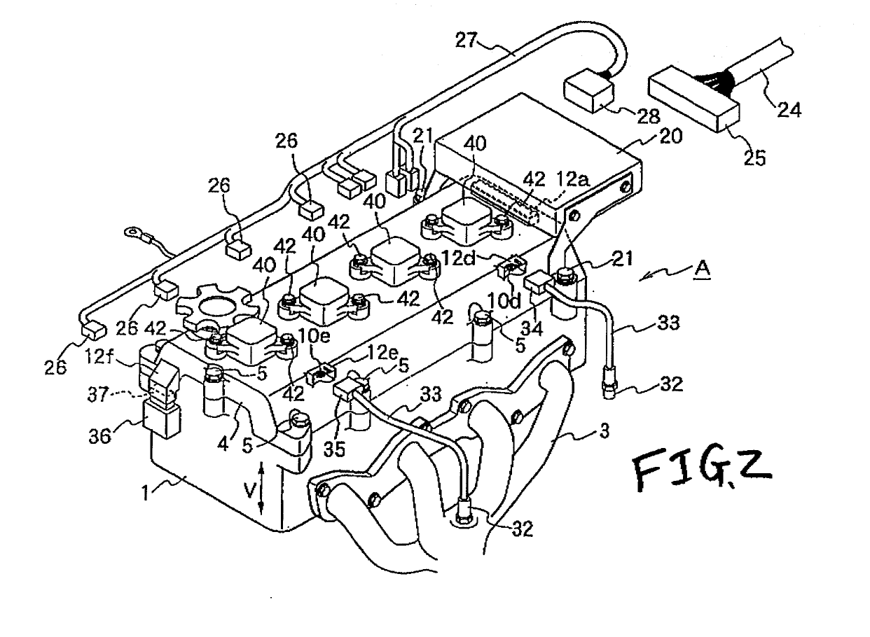

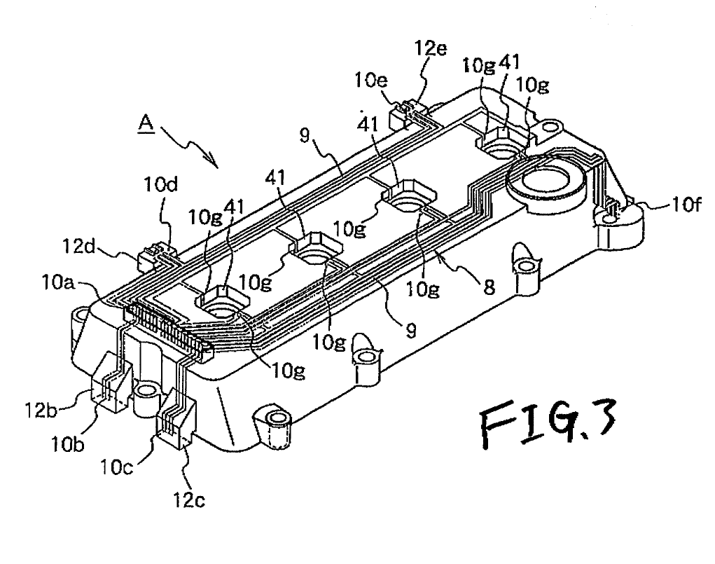

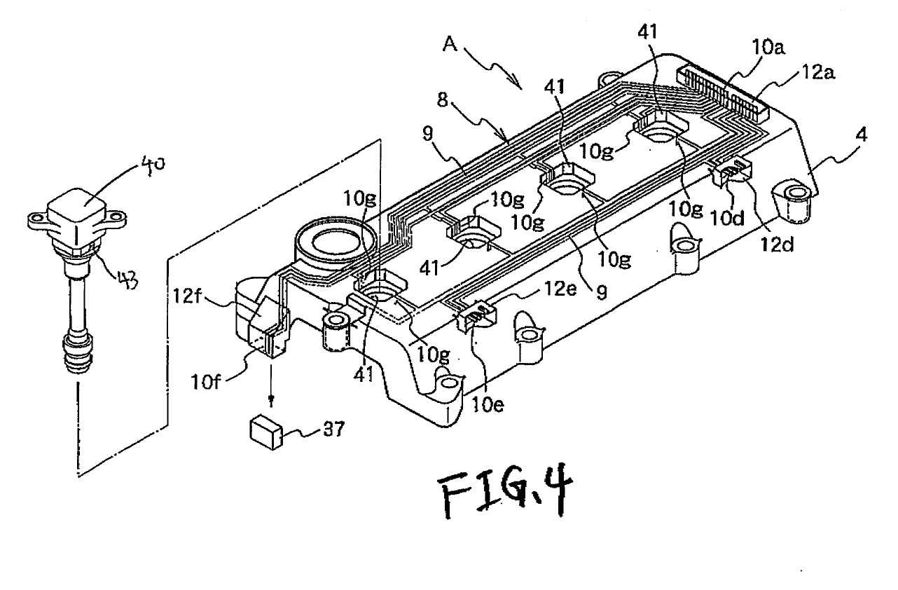

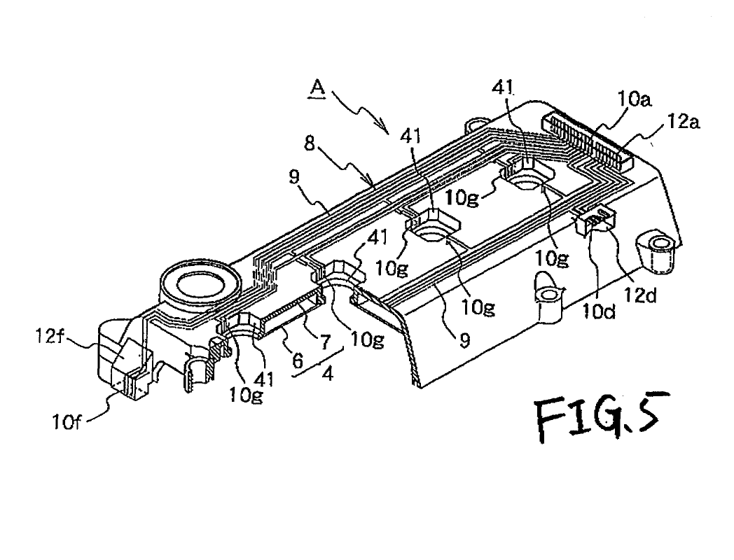

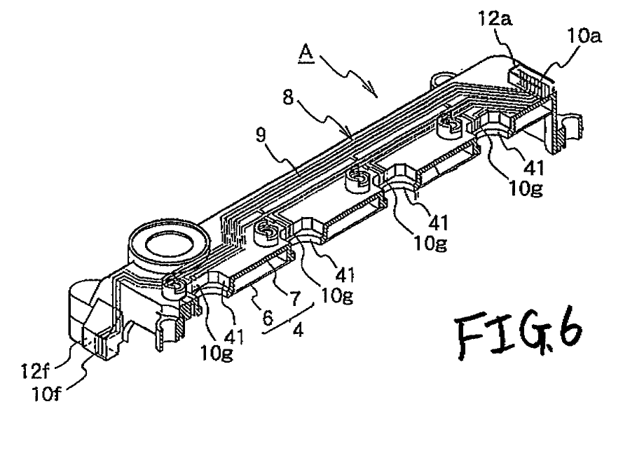

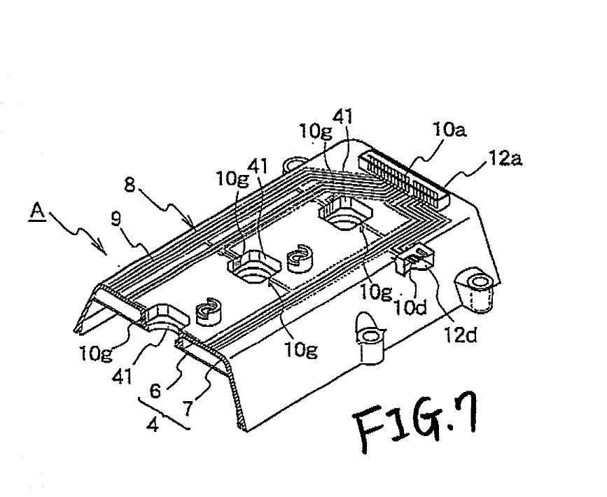

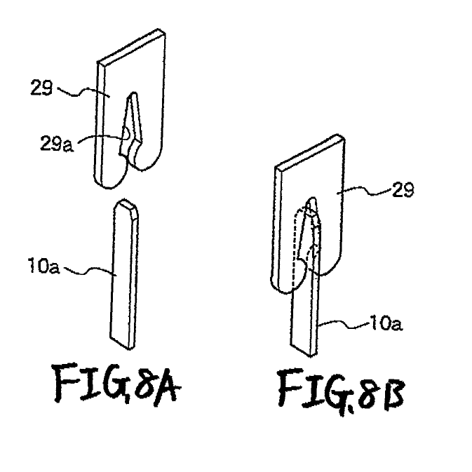

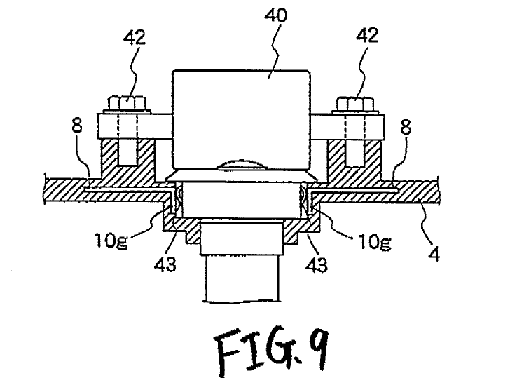

FIGS. 1 to 9 show an engine to which the built-in engine type control apparatus according to the embodiment of the invention is applied. FIG. 1 is a perspective view of the engine seen from the suction side thereof, FIG. 2 is a perspective view of the engine seen from the exhaust side thereof, FIG. 3 is a perspective view showing a cylinder head cover seen from the suction side in which a bus bar circuit body is looked through and shown clearly, FIG. 4 is a perspective view showing the cylinder head cover seen from the exhaust side in which the bus bar circuit body is looked through and shown clearly, FIGS. 5 to 7 are partially cutaway views of the cylinder head cover seen from the exhaust side in which cutaway portions of these figures differ from one another, FIG. 8A is a perspective view showing a state before a contact point on an engine control unit side and a contact point on the cylinder head cover side are made in contact, FIG. 8B is a perspective view showing a state where the contact point on the engine control unit side and the contact point on the cylinder head cover side are made in contact, and FIG. 9 is a sectional view showing a state where a built-in ignition coil type igniter is attached.

As shown in FIGS. 1 and 2, suction tubes 2 and exhaust tubes 3 are coupled to an engine main body 1 in a manner that air sucked from the suction tubes 2 is supplied to cylinder chambers (not shown) within the engine main body 1 and burnt therein, and exhaust gas generated from the cylinder chambers (not shown) is exhausted from the exhaust tubes 3. The cylinder head cover 4 as the apparatus main body of the built-in engine type control apparatus A is fixed to the upper surface of the engine main body 1 by means of bolts 5 etc., whereby the opening at the upper portion of the engine is closed by the cylinder head cover 4.

As shown in detail in FIGS. 3 to 7, the cylinder head cover 4 is formed by heat resistant insulating material and configured in a two layer structure of a baffle plate 6 and an upper cover portion 7 disposed with a constant distance from the baffle plate 6. A bus bar circuit body 8 is buried in the upper cover portion 7. The bus bar circuit is made of metal such as copper alloy including such as brass and red brass, pure copper, aluminum alloy and the like. The bus bar circuit body 8 is constituted by a branch circuit portion 9 serving as a wiring portion of the engine control circuit and a plurality of contact points 10a to 10g integrally formed by using terminal portions forming the branch circuit portion 9. Each of the contact points 10a to 10g constitute a contact point group formed by contact points disposed nearly from one another. In this embodiment, the plurality of the contact points 10a constitute a contact point group for an engine control unit 20, the plurality of the contact points 10b constitute a contact point group for a water temperature detection sensor, the plurality of the contact points 10c constitute a contact point group for a cam shaft phase detection sensor, two plurality of the contact points 10d, 10e constitute two contact point groups for an oxygen amount detection sensor, the plurality of the contact points 10f constitute a contact point group for valves for controlling the valve timing, and four groups of plurality of the contact points 10g constitute four contact point groups for a built-in ignition coil type igniter 40.

First to sixth connector fitting portions 12a to 12f are provided at the peripheries of the other contact points 10a to 10f except for the four contact points 10g for the built-in ignition coil type igniter 40, respectively. The connector fitting portions 12a to 12f are provided integrally with the cylinder head cover 4. The respective contact points 10a to 10f disposed within the first to sixth connector fitting portions 12a to 12f are exposed so as to protrude from the surface of the cylinder head cover 4, respectively. The four groups of the plurality of the contact points 10g for the built-in ignition coil type igniter 40 are disposed at the end surfaces of ignition coil attachment ports 41 and exposed from the cylinder head cover 4 so as to be along the end surfaces thereof, respectively.

The engine control unit 20 as an electric part is fixed on the upper surface of the cylinder head cover 4 through bolts 21 (shown in FIG. 2). An engine control circuit portion (not shown) is mounted on the engine control unit 20. Further, three connectors for inputting outputs of various kinds of sensors etc. and outputting a control signal are provided at the engine control circuit portion (not shown). The two connectors 22, 23 are provided at the side surface of the engine control unit 20. A connector 25 for harnesses 24 introduced from an engine room and a connector 28 for harnesses 27 introduced to injectors 26 etc. are fitted into the two connectors 22, 23, respectively. The remaining one connector (not shown) is provided at the bottom surface of the engine control unit 20 and this connector (not shown) is fitted into the first connector fitting portion 12a of the cylinder head cover 4. To be more concrete, as shown in FIGS. 8A and 8B, each of the plurality of the contact points 10a on the cylinder head cover 4 side is erected upward and has a plate shape. Each of a plurality of contact points 29 on the engine control unit 20 side has a slit 29a directed upward from the center portion of the lower end surface of the contact point 29 so as to form a gripping plate shape. When the contact point 10a on the cylinder head cover 4 side is inserted into the slit 29a of the contact point 29 on the engine control unit 20 side, the both contact points 10a and 29 are electrically coupled to each other.

The water temperature detection sensor (not shown) and the cam shaft phase detection sensor (not shown) are contained within a temperature detection sensor 30a and a cam shaft phase detection sensor 30b, respectively. A connector 31a coupled to the water temperature detection sensor (not shown) and a connector 31b coupled to the cam shaft phase detection sensor (not shown) are fitted into the second and third connector fitting portions 12b, 12c of the cylinder head cover 4, respectively. Connectors 34, 35 are provided at the terminals of electric wires 33 coupled to two oxygen amount detection sensors 32 as electric parts, respectively. These connectors 34, 35 are fitted into the fourth and fifth connector fitting portions 12d, 12e of the cylinder head cover 4, respectively. A connector 37 as an electric part coupled to valves 36 for controlling valve timings is fitted into the sixth connector fitting portion 12f of the cylinder head cover 4. The fitting direction between the connectors 31a, 31b, 37 and the second, third and sixth connector fitting portions 12b, 12c, 12f is set to be almost same as the vibration direction V of the engine.

As illustrated in detail in FIG. 9, the built-in ignition coil type igniter 40 as an electric part is fixed to the cylinder head cover 4 by means of bolts 42 in a state of being inserted within the ignition coil attachment port 41. A plurality of contact points 43 to be supplied with an ignition current are provided at the side surface of the built-in ignition coil type igniter 40. These plurality of the contact points 43 are made in contact with the contact points log of the cylinder head cover 4, respectively.

In the engine provided with the built-in engine type control apparatus A according to the invention, since the branch circuit portion 9 and the plurality of the contact points 10a to 10g are integrally formed by the bus bar Circuit body 8 by utilizing the terminals of the branch circuit portion, it is not necessary to provide a process of coupling the branch circuit portion and the plurality of the contact points like the related technique. Thus, since the control apparatus can be prepared by such a processing of integrally forming the bus bar circuit body 8 formed through the press molding with the cylinder head cover 4, the control apparatus can be fabricated easily at a low cost. Further, the bus bar circuit body 8 has rigidity as a structural element, so that the dimensional accuracy can be easily secured at the time of burying the bus bar circuit body. Further, since the bus bar circuit body 8 does not cause an inconvenience such as deformation with respect to the manufacturing temperature (for example, 150° C. for FPR resin, 300° C. for nylon resin) at the time of burying procedure, the degree of freedom for selecting material of the cylinder head cover 4 can be large.

According to the embodiment, the first to sixth connector fitting portions 12 to 12f to which the connector (not shown) and the connectors 31a, 31b, 34, 35, 37 respectively coupled to the engine control unit 20, the temperature detection sensor 30a, the cam shaft phase detection sensor 30b, the oxygen amount detection sensor 32 each serving as an electric part and the valves 36 for controlling the valve timings are fitted and at which the plurality of the contact points 10a to 10f are disposed are provided at the cylinder head cover 4. Thus, since the electric parts can be coupled by fitting the connector (not shown) and the connectors 31a, 31b, 34, 35, 37 into the connector fitting portions 12a to 12f of the cylinder head cover 4, respectively, the electric parts including the engine control unit 20 can be coupled easily. Further, since the electric coupling of the built-in ignition coil type igniter 40 can be completed by attaching the built-in ignition coil type igniter 40 to the ignition coil attachment port 41, the attaching procedure of the built-in ignition coil type igniter 40 can be performed easily.

According to the embodiment, the fitting direction between the connectors 31a, 31b, 37 coupled to the water temperature detection sensor (not shown), the cam shaft phase detection sensor (not shown) each serving as an electric part and the valves 36 for controlling the valve timings and the second to fourth connector fitting portions 12b, 12c, 12f is set to be almost same as the vibration direction V of the engine. Thus, since the vibration in the mutually sliding direction acts on each of the contact points (not shown) and the contact points 10b, 10c, 10f of each of the connectors and the connector fitting portions, the breakage of the contact points (not shown) and the contact points 10b, 10c, 10f due to the vibration of the engine can be prevented.

According to the embodiment, since the apparatus main body is the cylinder head cover 4 for closing the opening at the upper portion of the engine, it is not necessary to provide, separately from the cylinder head cover 4, a member at which the bus bar circuit body 8 is provided, the number of the parts can be reduced.

As described above, according to the invention, in the built-in engine type control apparatus which is coupled to the electric parts and has the branch circuit portion, the built-in engine type control apparatus includes:

the apparatus main body formed by the heat resistant insulating material; and

the bus bar circuit body which is buried in the apparatus main body and in which the branch circuit portion is formed and a plurality of the contact points to be coupled to the electric parts are formed integrally with the terminals. Thus, since the branch circuit portion and the plurality of the contact points are integrally formed by the bus bar circuit body by using the terminals of the branch circuit portion, it is not necessary to provide a process of coupling the branch circuit portion and the plurality of the contact points like the conventional technique. Accordingly, since the control apparatus can be prepared by such a processing of integrally forming the bus bar circuit body formed through the press molding with the apparatus main body, the control apparatus can be fabricated easily at a low cost.

According to the invention, the connector fitting portion at which the plurality of the contact points are disposed and in which the connector coupled to the electric parts is fitted is provided at the apparatus main body. Thus, since the electric parts can be coupled by fitting the connector on the electric part side into the connector fitting portion of the apparatus main body, the electric parts can be coupled easily.

According to the invention, a fitting direction between the connector coupled to the electric parts and the connector fitting portion is set to be almost same as a vibration direction of the engine. Thus, since the vibration in the mutually sliding direction acts on each of the contact points due to the vibration of the engine, the breakage of the contact points due to the vibration of the engine can be prevented.

According to the invention, the apparatus main body is the cylinder head cover which closes the opening at the upper portion of the engine. Thus, since it is not necessary to provide, separately from the cylinder head cover, a member at which the bus bar circuit body is provided, the number of the parts can be reduced.

What is claimed is:

1. A built-in engine type control apparatus comprising:
an apparatus main body formed by heat resistant insulating material; and
a bus bar circuit body which is buried in the apparatus main body and includes a branch circuit portion and a plurality of contact points, to be coupled to electric parts attached to outer periphery of an engine, each of which are integrally formed at terminals of the branch circuit portion, respectively.

2. The built-in engine type control apparatus according to claim 1, wherein a connector fitting portion at which the plurality of contact points are disposed and in which a connector coupled to the electric parts is fitted is provided at the apparatus main body.

3. The built-in engine type control apparatus according to claim 2, wherein a fitting direction in which the connector coupled to the electric parts is fitted to the connector fitting portion is set to be substantially same as a vibration direction of the engine.

4. The built-in engine type control apparatus according to claim 1, wherein the apparatus main body is a cylinder head cover which closes an opening at an upper portion of the engine.
